(19) United States
(12) Patent Application Publication
(10) Pub. No.: US 2017/0175532 A1
(43) Pub. Date: Jun. 22, 2017

(54) ANGLED HEAT TRANSFER PEDESTAL

(71) Applicant: United Technologies Corporation, Farmington, CT (US)

(72) Inventors: Christopher King, Bristol, CT (US); San Quach, Southington, CT (US); Rohan Mehta, Middletown, CT (US)

(21) Appl. No.: 14/975,924

(22) Filed: Dec. 21, 2015

(51) Int. Cl. F01D 5/14; F02C 3/04; F01D 25/12; F01D 5/18; F01D 9/04

(52) U.S. Cl. CPC F01D 5/147; F01D 5/187; F01D 9/041; F01D 25/12; F02C 3/04; F05D 2220/32; F05D 2240/81; F05D 2260/202; F05D 2260/22141; F05D 2240/35

(57) ABSTRACT

A gas turbine engine component includes a body defining a cooling inlet and a cooling outlet in fluid communication through a cooling channel extending through the body, and a plurality of pedestals positioned in the cooling channel. The plurality of pedestals arranged such that the adjacent pedestals alternatingly converge toward a first wall of the cooling channel and toward a second wall, opposite the first wall. A gas turbine engine includes a combustor, and a plurality of gas turbine engine components positioned in fluid communication with the combustor. Each component includes a body defining a cooling inlet and a cooling outlet in fluid communication through a cooling channel extending through the body. A plurality of pedestals are positioned in the cooling channel and are arranged such that the adjacent pedestals alternatingly converge toward a first wall of the cooling channel and toward a second wall, opposite the first wall.

### STATEMENT OF GOVERNMENT RIGHTS

This invention was made with government support under Contract Number N68335-13-C-0005 awarded by the Navy. The government has certain rights in the invention.

### BACKGROUND

This disclosure relates to gas turbine engines, and more particularly to thermal and structural management of turbine components of gas turbine engines.

Gas turbines hot section components, in particular turbine vanes and blades in the turbine section of the gas turbine are configured for use within particular temperature ranges. Often, the conditions in which the components are operated exceed a maximum useful temperature of the material of which the components are formed. Thus, such components often rely on cooling airflow to cool the components during operation. For example, stationary turbine vanes often have internal passages for cooling airflow to flow through, and additionally may have openings in an outer surface of the vane for cooling airflow to exit the interior of the vane structure and form a cooling film of air over the outer surface to provide the necessary thermal conditioning. The internal passages often include pedestals extending across the internal passages, which increase structural support of the component and increase thermal conductivity between the outer surfaces of the component and the cooling flow passing therethrough. The typical pedestal, however, is subjected to high levels of stresses during operation of the gas turbine engine, and ways to reduce stresses while enhancing cooling of the components are desired.

### SUMMARY

In one embodiment, a gas turbine engine component includes a body defining a cooling inlet and a cooling outlet in fluid communication with each other through a cooling channel extending through the body, and a plurality of pedestals positioned in the cooling channel. The plurality of pedestals arranged such that the adjacent pedestals alternatingly converge toward a first wall of the cooling channel and toward a second wall of the cooling channel, opposite the first wall.

Additionally or alternatively, in this or other embodiments a plurality of pedestals are arranged in a plurality of longitudinally-extending rows.

Additionally or alternatively, in this or other embodiments at least one pedestal of the plurality of pedestals intersects the first wall and/or the second wall at an angle between 10 degrees and 90 degrees relative to a component longitudinal axis.

Additionally or alternatively, in this or other embodiments at least one pedestal of the plurality of pedestals intersects the first wall and/or the second wall at an angle between 10 degrees and 90 degrees relative to a radial axis of the component.

Additionally or alternatively, in this or other embodiments at least one pedestal of the plurality of pedestals intersects the first wall and/or the second wall at an angle between 10 degrees and 90 degrees relative to a radial axis of the component and at an angle between 10 degrees and 90 degrees relative to a longitudinal axis of the component.

Additionally or alternatively, in this or other embodiments the arrangement of the plurality of pedestals is selected to reduce stresses at the component and/or to improve thermal energy transfer between the component and a cooling airflow directed therethrough.

Additionally or alternatively, in this or other embodiments the arrangement of the plurality of pedestals defines a truss-like structure.

In another embodiment, an airfoil for a gas turbine engine includes a platform portion, an airfoil portion extending radially outwardly from the platform portion, the airfoil portion having at least one cooling channel located therein, and a plurality of pedestals positioned in the cooling channel. The plurality of pedestals are arranged such that the adjacent pedestals alternatingly converge toward a first wall of the cooling channel and toward a second wall of the cooling channel, opposite the first wall.

Additionally or alternatively, in this or other embodiments a cooling airflow inlet is located at the platform portion in fluid communication with the cooling channel.

Additionally or alternatively, in this or other embodiments a cooling airflow outlet is located at one or more of the airfoil portion or the platform portion in fluid communication with both the cooling channel and the cooling airflow inlet.

Additionally or alternatively, in this or other embodiments the cooling airflow outlet is located at one or more of a trailing edge, pressure side or suction side of the airfoil portion, or the platform portion.

Additionally or alternatively, in this or other embodiments a plurality of pedestals are arranged in a plurality of longitudinally-extending rows.

Additionally or alternatively, in this or other embodiments at least one pedestal of the plurality of pedestals intersects the first wall and/or the second wall at an angle between 10 degrees and 90 degrees relative to an airfoil longitudinal axis.

Additionally or alternatively, in this or other embodiments at least one pedestal of the plurality of pedestals intersects the first wall and/or the second wall at an angle between 10 degrees and 90 degrees relative to a radial axis of the airfoil.

Additionally or alternatively, in this or other embodiments at least one pedestal of the plurality of pedestals intersects the first wall and/or the second wall at an angle between 10 degrees and 90 degrees relative to a radial axis of the airfoil and at an angle between 10 degrees and 90 degrees relative to a longitudinal axis of the airfoil.

Additionally or alternatively, in this or other embodiments the arrangement of the plurality of pedestals is selected to reduce stresses at the airfoil and/or to improve thermal energy transfer between the airfoil and a cooling airflow directed therethrough.

In yet another embodiment, a gas turbine engine includes a combustor, and a plurality of gas turbine engine components positioned in fluid communication with the combustor. Each gas turbine engine component includes a body defining a cooling inlet and a cooling outlet in fluid communication with each other through a cooling channel extending through the body. A plurality of pedestals are positioned in the cooling channel. The plurality of pedestals are arranged such that the adjacent pedestals alternatingly converge toward a first wall of the cooling channel and toward a second wall of the cooling channel, opposite the first wall.

Additionally or alternatively, in this or other embodiments at least one pedestal of the plurality of pedestals intersects the first wall and/or the second wall at an angle between 10 degrees and 90 degrees relative to a component longitudinal axis.

Additionally or alternatively, in this or other embodiments at least one pedestal of the plurality of pedestals intersects the first wall and/or the second wall at an angle between 10 degrees and 90 degrees relative to a radial axis of the component.

Additionally or alternatively, in this or other embodiments at least one pedestal of the plurality of pedestals intersects the first wall and/or the second wall at an angle between 10 degrees and 90 degrees relative to a radial axis of the component and at an angle between 10 degrees and 90 degrees relative to a longitudinal axis of the component.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic illustration of a gas turbine engine;

FIG. 2 is a side view of an embodiment of a turbine blade for a gas turbine engine;

FIG. 3 is a cross-sectional view of an embodiment of a turbine blade for a gas turbine engine;

FIG. 4 is another cross-sectional view of an embodiment of a turbine blade for a gas turbine engine; and

FIG. 5 is yet another cross-sectional view of an embodiment of a turbine blade for a gas turbine engine

### DETAILED DESCRIPTION

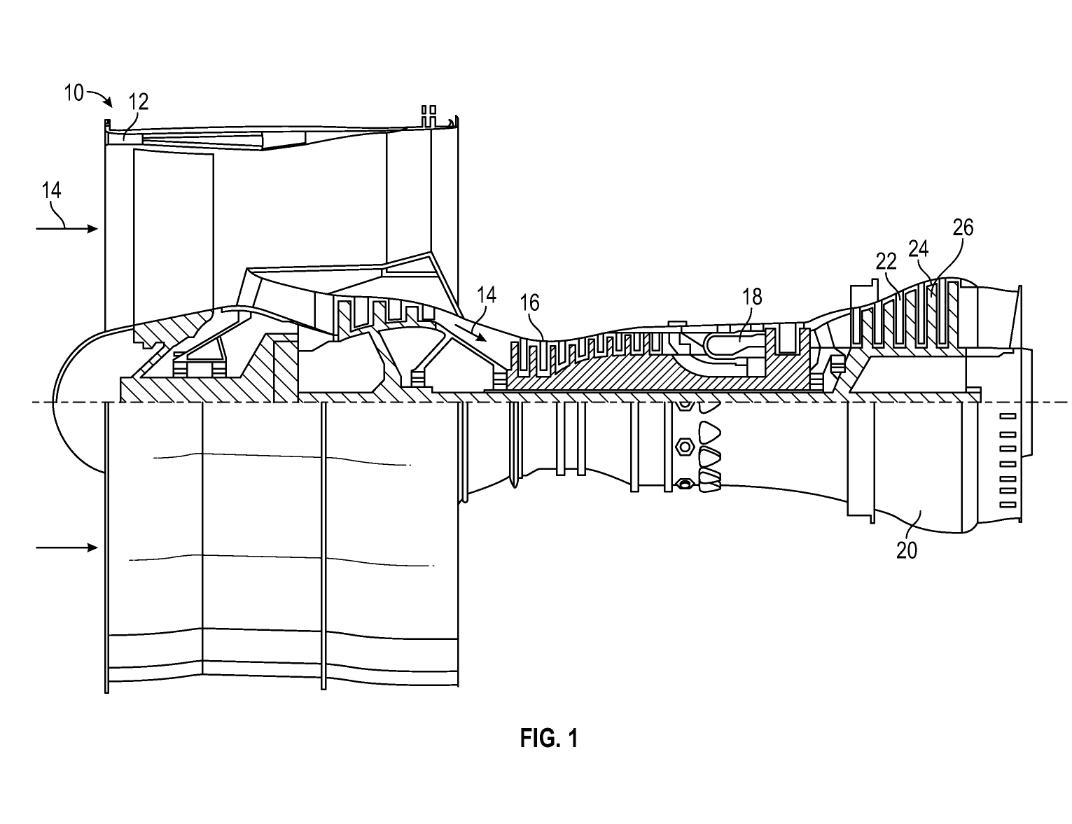

FIG. 1 is a schematic illustration of a gas turbine engine 10. The gas turbine engine generally has a fan 12 through which ambient air is propelled in the direction of arrow 14, a compressor 16 for pressurizing the air received from the fan 12 and a combustor 18 wherein the compressed air is mixed with fuel and ignited for generating combustion gases.

The gas turbine engine 10 further comprises a turbine section 20 for extracting energy from the combustion gases. Fuel is injected into the combustor 18 of the gas turbine engine 10 for mixing with the compressed air from the compressor 16 and ignition of the resultant mixture. The fan 12, compressor 16, combustor 18, and turbine 20 are typically all concentric about a common central longitudinal axis of the gas turbine engine 10.

The gas turbine engine 10 may further comprise a low pressure compressor located upstream of a high pressure compressor and a high pressure turbine located upstream of a low pressure turbine. For example, the compressor 16 may be a multi-stage compressor 16 that has a low-pressure compressor and a high-pressure compressor and the turbine 20 may be a multistage turbine 20 that has a high-pressure turbine and a low-pressure turbine. In one embodiment, the low-pressure compressor is connected to the low-pressure turbine and the high pressure compressor is connected to the high-pressure turbine.

The turbine 20 includes one or more sets, or stages, of fixed turbine vanes 22 and turbine rotors 24, each turbine rotor 24 including a plurality of turbine blades. The turbine vanes 22 and the turbine blades 26 utilize a cooling airflow to maintain the turbine components within a desired temperature range. In some embodiments, the cooling airflow may flow internal through the turbine components to cool the components internally, while in other embodiments, the cooling airflow is utilized to form a cooling film on exterior surfaces of the components.

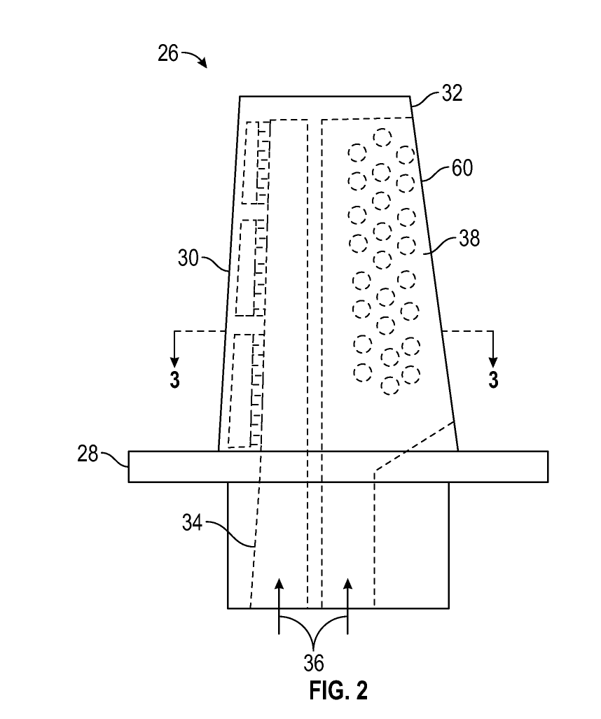

FIG. 2 illustrates an embodiment of a turbine blade 26 in more detail. While a turbine blade 26 is described herein and illustrated in the accompanying figures, one skilled in the art will readily appreciate that the disclosure herein may be applied to other components, such as turbine vanes 22, or other components having internal airflow passages. The turbine blade 26 includes a blade platform 28 and an airfoil portion 30 extending from the blade platform 28 to a blade tip 32. The blade platform 28 may include a cooling airflow inlet 34 to direct a cooling airflow 36 into an interior of the turbine blade 26. Further the turbine blade 26 may include a cooling airflow outlet 38 at, for example, a trailing edge 60 of the airfoil portion 30 of the turbine blade 26. The cooling airflow 36 is directed through the turbine blade 26 to cool the turbine blade 26 allowing for its continued operation.

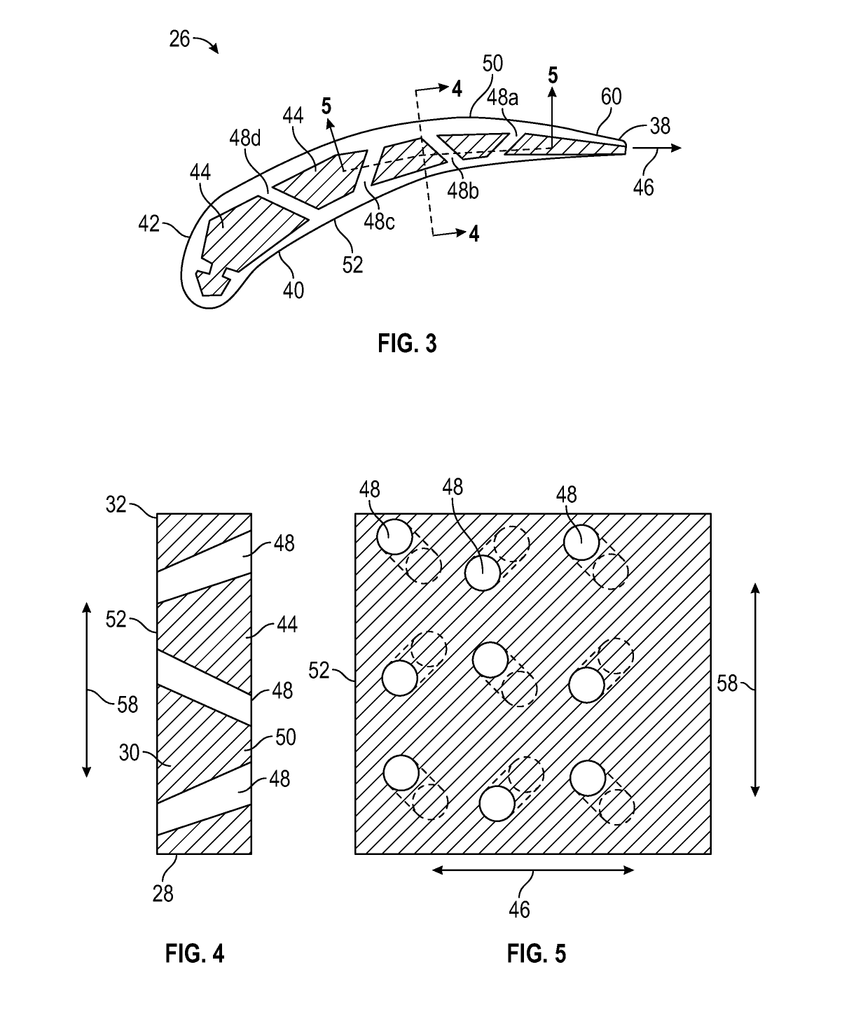

Referring now to FIG. 3, shown is a cross-sectional view of an embodiment of the turbine blade 26. The turbine blade 26 includes a pressure side 40 and a suction side 42, with one or more cooling passages 44 located between the pressure side 40 and the suction side. The cooling passages 44 are in flow communication with the cooling airflow inlet 34 and the cooling airflow outlet 38. One or more pedestals 48 are located in the cooling passage 44 and extend from a suction side wall 50 to a pressure side wall 52. The pedestals 48 or a portion thereof intersect one or both of the suction side wall 50 or pressure side wall 52 at a non-right angle. The pedestals 48 may intersect the side walls 50, 52 at any suitable angle, for example, between about 10 degrees and about 90 degrees.

In the embodiment of FIGS. 3-5, the arrangement of pedestals 48 defines a truss-like structure. In the cross-sectional view of FIG. 3, pedestals 48a, 48b, 48c, 48d are arranged along a longitudinal axis 46, defined parallel to a central longitudinal axis of the gas turbine engine 10, and across the cooling passage 44. Pedestals 48a and 48b are configured such that a distance between pedestals 48a and 48b along the suction side wall 50 is greater than a distance between pedestals 48a and 48b along the pressure side wall 52. Between pedestals 48b and 48c, the relationship may be reversed, with a distance between pedestals 48b and 48c along the pressure side wall 52 greater than a distance between pedestals 48b and 48c along the suction side wall 50. The relationship between pedestals 48c and 48d is defined with a distance between pedestals 48c and 48d along the suction side wall 50 is greater than a distance between pedestals 48c and 48d along the pressure side wall 52. It is to be appreciated that though four pedestals 48 are shown in FIG. 3 and described herein, other quantities of pedestals 48 may be utilized in other embodiments to define the truss-like arrangement of pedestals 48.

Referring now to FIG. 4, a plurality of pedestals 48 may also be arranged along a radial span of the airfoil portion 30 between the blade platform 28 and the blade tip 32. Similar to the arrangement shown in FIG. 3, the pedestals 48 may define a truss-like structure in the spanwise direction, with adjacent pedestals 48 alternatingly converging at the pressure side wall 52 and at the suction side wall 50. The cross-sectional view of FIG. 5 illustrates multiple longitudinal rows of pedestals 48, combining the alternating longitudinal arrangement shown in FIG. 3, with the alternating span-wise arrangement of FIG. 4, As shown in FIG. 5, the pedestals 48 may intersect both the suction side wall 52 and the pressure side wall 50 (not shown for clarity) at nonperpendicular angles between, for example, 10 degrees and 90 degrees relative to both the longitudinal axis 46 and a spanwise axis 58 of the turbine blade 26.

The angled pedestals 48 of any of the embodiments described herein allow for flow directional control and/or modification to enhance thermal control of components with cooling channels 44. As will be appreciated by one having ordinary skill in the art, the direction and degree of angle of the pedestals can be selected to modify impingement on a desired portion of the cooling channel to regulate temperatures at certain portions of the turbomachine component as desired. Further, the arrangement of the pedestals 48 may be selected to modify or direct a stress profile of the turbine blade 26. For example, if there is found to be a crack propagation at a certain location of the turbine blade 26, the pedestal 48 location, intersection points with the pressure side wall 52 and/or suction side wall 50 may be modified to change the crack location to a more suitable location or to modify heat transfer effectiveness to prevent the crack. Further, in some embodiments, the pedestals 48 may be configured and/or arranged to tune vibratory response of the turbine blade 26 away from undesired frequencies.

This solution is not limited to round angled pedestals 48 with circular cross-sections, but can include any shape such as oblong, oval, or elongated shapes. Applications that would utilize this application would be when a bias flow is needed towards the suction side or pressure side including the trailing edge lip on a center discharge refractory metal core. Further, the angled pedestals 48 may be utilized in applications where the cooling airflow outlets 38 are located at the blade platform 28, a blade suction surface, and/or a blade pressure surface, as an alternative to or in addition to cooling airflow outlets 38 at the blade trailing edge. Cases where Coriolis Effect is important due to very wide aspect ratio cavities can apply this application.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A gas turbine engine component, comprising:
a body defining a cooling inlet and a cooling outlet in fluid communication with each other through a cooling channel extending through the body; and
a plurality of pedestals disposed in the cooling channel, the plurality of pedestals arranged such that the adjacent pedestals alternatingly converge toward a first wall of the cooling channel and toward a second wall of the cooling channel, opposite the first wall.

2. The gas turbine engine component of claim 1, further comprising a plurality of pedestals arranged in a plurality of longitudinally-extending rows.

3. The gas turbine engine component of claim 1, wherein at least one pedestal of the plurality of pedestals intersects the first wall and/or the second wall at an angle between 10 degrees and 90 degrees relative to a component longitudinal axis.

4. The gas turbine engine component of claim 1, wherein at least one pedestal of the plurality of pedestals intersects the first wall and/or the second wall at an angle between 10 degrees and 90 degrees relative to a radial axis of the component.

5. The gas turbine engine component of claim 1, wherein at least one pedestal of the plurality of pedestals intersects the first wall and/or the second wall at an angle between 10 degrees and 90 degrees relative to a radial axis of the component and at an angle between 10 degrees and 90 degrees relative to a longitudinal axis of the component.

6. The gas turbine engine component of claim 1, wherein the arrangement of the plurality of pedestals is selected to reduce stresses at the component and/or to improve thermal energy transfer between the component and a cooling airflow directed therethrough.

7. The gas turbine engine component of claim 1, wherein the arrangement of the plurality of pedestals defines a truss-like structure.

8. An airfoil for a gas turbine engine, comprising:
a platform portion;
an airfoil portion extending radially outwardly from the platform portion, the airfoil portion having at least one cooling channel disposed therein; and
a plurality of pedestals disposed in the cooling channel, the plurality of pedestals arranged such that the adjacent pedestals altematingly converge toward a first wall of the cooling channel and toward a second wall of the cooling channel, opposite the first wall.

9. The airfoil of claim 8, further comprising a cooling airflow inlet disposed at the platform portion in fluid communication with the cooling channel.

10. The airfoil of claim 9, further comprising a cooling airflow outlet disposed at one or more of the airfoil portion or the platform portion in fluid communication with both the cooling channel and the cooling airflow inlet.

11. The airfoil of claim 10, wherein the cooling airflow outlet is disposed at one or more of a trailing edge, pressure side or suction side of the airfoil portion, or the platform portion.

12. The airfoil of claim 8, further comprising a plurality of pedestals arranged in a plurality of longitudinally-extending rows.

13. The airfoil of claim 8, wherein at least one pedestal of the plurality of pedestals intersects the first wall and/or the second wall at an angle between 10 degrees and 90 degrees relative to an airfoil longitudinal axis.

14. The airfoil of claim 8, wherein at least one pedestal of the plurality of pedestals intersects the first wall and/or the second wall at an angle between 10 degrees and 90 degrees relative to a radial axis of the airfoil.

15. The airfoil of claim 8, wherein at least one pedestal of the plurality of pedestals intersects the first wall and/or the second wall at an angle between 10 degrees and 90 degrees relative to a radial axis of the airfoil and at an angle between 10 degrees and 90 degrees relative to a longitudinal axis of the airfoil.

16. The airfoil of claim 8, wherein the arrangement of the plurality of pedestals is selected to reduce stresses at the airfoil and/or to improve thermal energy transfer between the airfoil and a cooling airflow directed therethrough.

17. A gas turbine engine, comprising:
a combustor; and
a plurality of gas turbine engine components disposed in fluid communication with the combustor, each gas turbine engine component including:
a body defining a cooling inlet and a cooling outlet in fluid communication with each other through a cooling channel extending through the body; and
a plurality of pedestals disposed in the cooling channel, the plurality of pedestals arranged such that the adjacent pedestals alternatingly converge toward a first wall of the cooling channel and toward a second wall of the cooling channel, opposite the first wall.

18. The gas turbine engine of claim 17, wherein at least one pedestal of the plurality of pedestals intersects the first wall and/or the second wall at an angle between 10 degrees and 90 degrees relative to a component longitudinal axis.

19. The gas turbine engine of claim 17, wherein at least one pedestal of the plurality of pedestals intersects the first wall and/or the second wall at an angle between 10 degrees and 90 degrees relative to a radial axis of the component.

20. The gas turbine engine of claim 17, wherein at least one pedestal of the plurality of pedestals intersects the first wall and/or the second wall at an angle between 10 degrees and 90 degrees relative to a radial axis of the component and at an angle between 10 degrees and 90 degrees relative to a longitudinal axis of the component.
